(19) United States
(12) Patent Application Publication
(10) Pub. No.: US 2008/0121738 A1
(43) Pub. Date: May 29, 2008

(54) CONTENT DISCHARGE MECHANISM AND AEROSOL TYPE PRODUCT AND PUMP TYPE PRODUCT EQUIPPED WITH THE MECHANISM

(75) Inventor: Hideo TOGASHI, TOKYO (JP)

Correspondence Address: LUCAS & MERCANTI, LLP, 475 PARK AVENUE SOUTH, 15TH FLOOR, NEW YORK, NY, 10016, US

(73) Assignee: MITANI VALVE CO. LTD., Tokyo (JP)

(21) Appl. No.: 11/969,685

(22) Filed: Jan. 4, 2008

Related U.S. Application Data
(63) Continuation-in-part of application No. PCT/JP2005/020121, filed on Nov. 1, 2005.

(30) Foreign Application Priority Data
Jul. 6, 2005 (JP) 2005-197530

(51) Int. Cl. B05B 7/10; B05B 7/32; G01F 11/00

(52) U.S. Cl. 239/406; 239/337; 222/321.8

(57) ABSTRACT

A spray nozzle mechanism capable of forming spray contents into fine particles. A channel setting core is fixedly placed in a space in a button body, between an output hole of a vertical path and a hole for discharging contents to the external space. Swirls in the same swirling direction are formed by upstream recessed paths continuous from the vertical path and downstream recessed paths continuous to the discharge hole. Also, the spray nozzle mechanism has ribs. The ribs move initial swirls created by the upstream recessed paths to the corresponding downstream recessed paths, where the initial swirls are moved in a state where they are separated as far as possible.

### TECHNICAL FIELD OF THE INVENTION

The present invention relates to a content discharge mechanism for making a fine mist from a discharge content to be discharged to an external space, and more particularly to a spray nozzle for use with an aerosol type product and a pump type product.

### BACKGROUND OF THE INVENTION

Spray nozzle generate a strong spiral discharge swirl flow by making a swirl flow (initial swirl flow) of the contents on the output side of a content passage which then moves a discharge hole due to pressing of the push button, the actuation mode setting. The nozzle design imparts additional swirl in the same direction as the initial swirl flow just short of the hole.

Further, the initial swirl flow on the output side of the content passage is substantially divided to a plurality of flows in the same swirl direction (a swirl flow not going round a swirl object plane). These swirl flows are joined just short of the discharge hole.

In the present specification, the term “swirl flow” includes a flow in a swirl direction that does not go round a swirl object plane as described above.

Moreover, the side of the discharge hole for a container content is assumed to be “front” and the opposite side “rear”. That is, the left side in FIGS. 1 and 2 means “front” and the right side “rear”.

The “pump type” indicates a system where the volume of a content accommodating space is reduced by pressing, for example, a peripheral part of a container is pressed by a user and the con-tents in the container is discharged to an external space.

Furthermore, an operation member for actuation mode setting includes push button type ones moving downward in operation and trigger lever type ones that rotate in operation.

Conventionally, a spray nozzle mechanism for aerosol type containers intended to atomize a content into a spray are known, for example in Japanese Unexamined Utility Model Application No. HEI3-32959.

As shown in the '959 application, a conventional spray nozzle mechanism is constructed as shown in FIGS. 5-10:

A columnar top [3′] for atomization of a spray content is disposed in a cylinder chamber [12] between a beak cylinder [1′] having an injection hole [13] formed in a front end wall [11] and an outlet side part of an injection passage of a push button [4] A recessed cavity or cave [32] and a plurality of tangential grooves [34] communicating with the former, are formed in a front wall surface [35] of the top [3′]/the front wall surface [35] and a rear wall surface [36] of the same. The tangential groove [34] is disposed to be antisymmetrical between the front wall surface [35] and the rear wall surface [36]. The top [3′] is rotated by the action of pressurized fluid (content) passing through the tangential groove [34].

The content in the container sent from the stem side is, in the case where the cave [32] and the tangential groove [34] are formed also in the rear wall surface [36] sprayed into the external space through a route of a spray passage [21] the cave [32] in the rear wall surface [36] the tangential groove [34] of the rear wall surface [36]-a space region among the external peripheral surface, the beak cylinder [1′], and the internal peripheral surface the tangential groove [34] of the front wall surface [35] the cave [32] of the front wall surface [35] the spray hole [13].

The content (pressurized fluid) entering the cave [32] from a plurality of the tangential grooves [34] in the front wall surface [35] forms a swirl flow along its peripheral wall and is discharged from the spray hole [13] into the external space as fine mist.

### OBJECTS OF THE INVENTION

The prior art nozzle mechanism for atomizing spray content experiences reverse phases in the disposition of a plurality of the tangential grooves in the front wall surface [35] and that of the tangential groove [34] in the rear wall surface [36], which does not utilize swirl flows based on the tangential grooves in the opposite surfaces synergetically.

It is an object of the present invention to provide a content discharge mechanism for making effective fine mist discharge operation of a container content by (a) fixedly disposing a core-shaped member (corresponding to the aforementioned top [3′]) for flow passage setting in a space region (corresponding to the aforementioned cylinder chamber [12]) between an output part of a content passage region of and a content discharge hole part to an external space to produce swirl flows in the same rotation direction at an upstream side flow passage part, continuous from the content passage region and at downstream side flow passage part, continuous to the content discharge hole part; and (b) moving a plurality of initial swirl flows produced at the upstream side flow passage part to a corresponding swirl flow production part of the downstream side flow passage part in a separated state.

### SUMMARY OF THE INVENTION

These another objects are obtained by the spray nozzle of the present invention. Broadly, the present invention is designed as a content discharge mechanism comprises:

1. a member for passage including a downstream passage region of a content and a sheath-shaped space region on a bottom surface of which an output part of the downstream passage region is formed;

2. a sheath-shaped discharge member attached to the sheath-shaped space region with its side of said output part being opened and including a hole for content discharge formed in its bottom surface on an external space side located oppositely to the side of the output part;

3. a core-shaped member making contact with respective bottom portions of the sheath-shaped space region and the discharge member and fixed to the member for passage and the discharge member to produce the space for passage of the content between it and an internal peripheral surface of the discharge member;

4. a plurality of upstream side passages provided on at least one of abutment parts of the member for passage and the core-shaped member so as to communicate the output part of the downstream passage region and the space for passage; and

5. a plurality of downstream side passages provided on at least one of the abutment parts of the discharge member and the core-shaped member for guiding the content advancing from the space for passage in the form of a spiral flow to the hole part for content discharge in the same direction as the spiral flow.

6. More, preferably, a plurality of rib-shaped parts are formed on at least one of the internal peripheral surface of the discharge member and an external peripheral surface for individually restricting a flow of the con-tent from each of the upstream side passages and for guiding and holding the core-shaped member.

The content discharge mechanism described above, and an aerosol type product and a pump type product both including the content discharge mechanism are objects of the present invention.

### EFFECT OF THE INVENTION

In accordance with the present invention, as described above, the sheath-shaped nozzle piece etc. having the discharge hole part of the content into the external space and the core-shaped member therein are fixed in the sheath-shaped space on the output side of the push button body having the content passage region, and the content is sent to the discharge hole part after the content is made the initial spiral flow at an output side part of the button body etc. and at a front part (just upstream side) of the discharge hole this is further developed into a strong discharge spiral flow in the same direction.

A plurality of the initial swirl flows generated at the output side part are moved to a corresponding input side of the spiral flow generation part of a front part (just upstream part) of the discharge hole part, as well separated as possible, based on the action of the rib-shaped member set in the passage space region thereof.

It is hereby possible to make a content discharged into an external space fine mist by enabling a content sent from the container body side to be supplied to the discharge hole part in a strong discharge swirl flow in the form of evolved initial spiral flow thereof.

### BRIEF DESCRIPTION OF THE DRAWINGS

These and other aspects of the present invention may be more fully understood by reference to one or more of the following drawings:

FIG. 1 is a view illustrating a cross section of a push button equipped with a mechanism for making a discharge content fine mist;

FIG. 2 is a view illustrating the mechanism for making a discharge content fine mist:

FIG. 3 illustrates cross sections of an input side and output side of the mechanism wherein (a) is a view illustrating an input side cross section based on a chain line A-A′ of FIG. 2 and (b) a view illustrating an output side based on a chain line B-B′ of FIG. 2;

FIG. 4 is a view illustrating each constitutional component of the mechanism of FIG. 1, and

FIGS. 5-10 illustrate a nozzle for the background of the Invention.

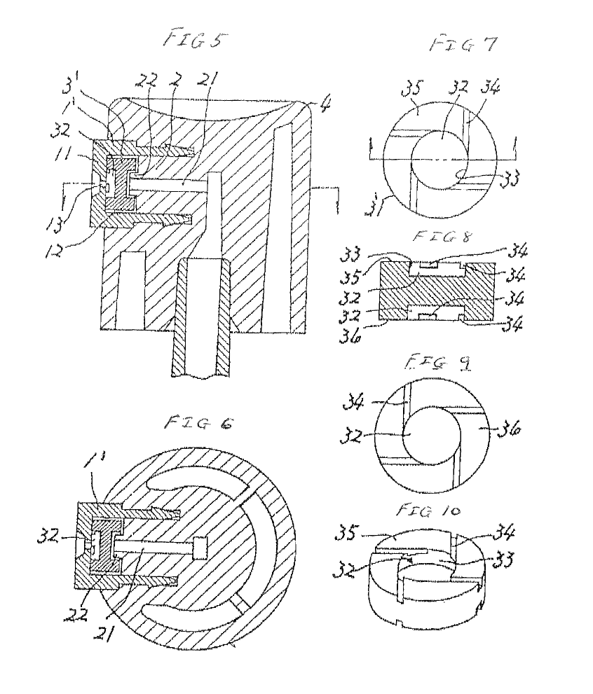

### DESCRIPTION OF REFERENCE CHARACTERS

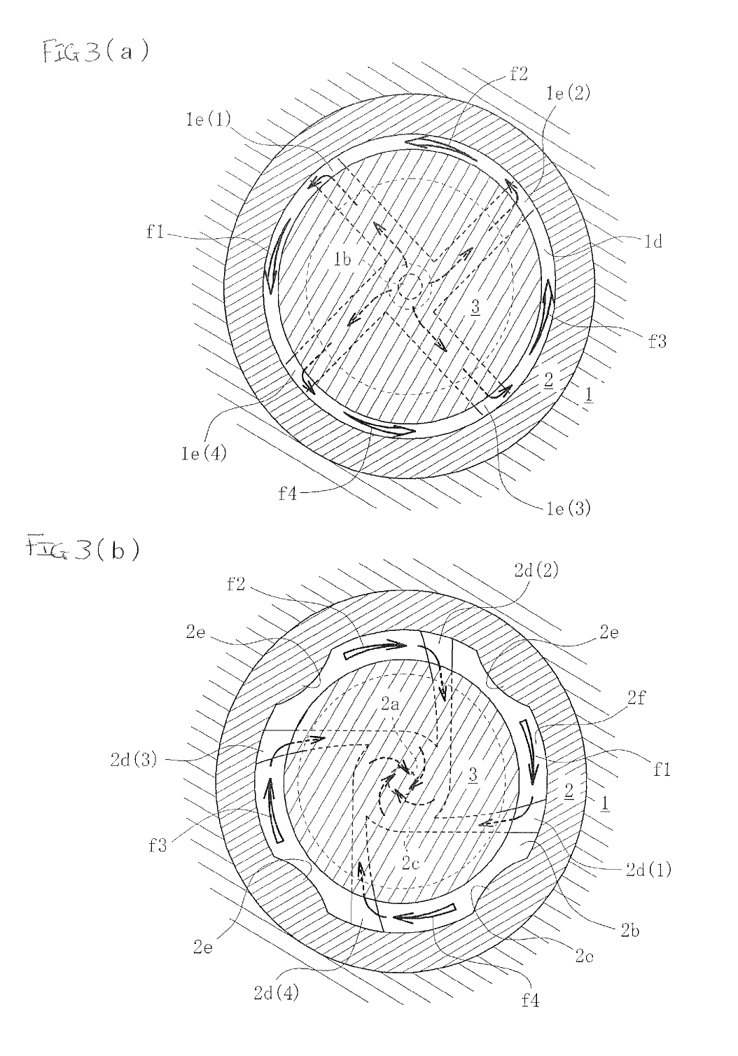

The following constituent components indicated by reference numbers each with an alphabet (e.g., discharge hole 2a) denote parts of those without alphabet (e.g., nozzle piece).
1: push button body equipped with a mechanism for making discharge content fine mist
1a: vertical passage of a content
1b: output hole part of the vertical passage
1c: downstream side sheath-shaped space region
1d: bottom surface part (of the sheath-shaped space region) having the output hole part substantially at the center thereof
1e: linear upstream side recessed passages (four) formed on the bottom surface part extending from the output hole part to an internal peripheral surface side of the sheath-shaped space region
1e(1) to 1e(4): upstream side recessed passage (only FIG. 3)
1f: annular recessed part engaging with stepped annular protruded part 2g of a nozzle piece 2 described later
2: sheath-shaped nozzle piece united engaged with the sheath-shaped space region to
2a: discharge hole for content
2b: bottom surface part having the discharge hole substantially at the center thereof
2c: circular recessed part formed in the bottom surface part in the form of surrounding the discharge hole
2d: downstream side recessed passages (four) each formed in the bottom surface part from the internal peripheral surface side of the nozzle piece to the circular recessed part
2d(1) to 2d(4): downstream side recessed passage (only FIG. 3)
2e: longitudinal ribs (four) having a function of regulating a swirl flow of contents formed longitudinally of the internal peripheral surface and sent from the upstream recessed passage 1e, of reducing mixing of initial swirl flows as mush as possible, and of guiding and holding a core 3 described later
2f: space regions (four) for content passage formed between the ribs in the state where the core is maintained as illustrated in the figure
2g: stepped annular protrusion for engagement with the push button body 1
3: columnar core fixed in contact with a bottom surface part 1d of the push button body 1, a bottom surface part 2b of the nozzle piece 2, and each of the ribs 2e
4: stem fixed below the vertical passage 1a of the pushbutton body 1 for changing well known changeover means (changeover between a stem gasket and a stem hole part in case of an aerosol container; changeover of a downstream valve in case of a pump container) from a previous closed state to an open state of the actuation mode following press operation of the push button f1 to f4 initial swirl flow (only FIG. 3)

### DETAILED DESCRIPTION OF THE INVENTION

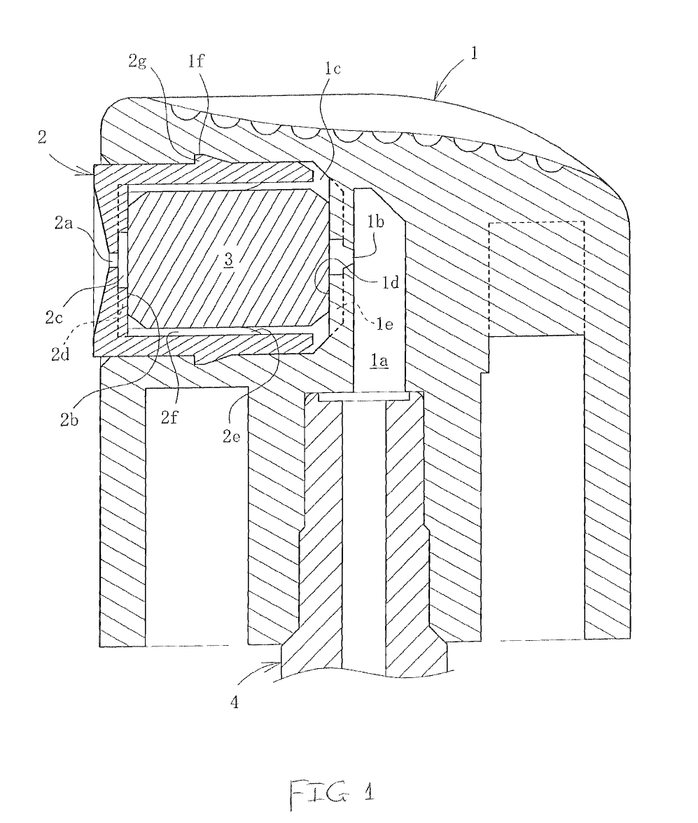

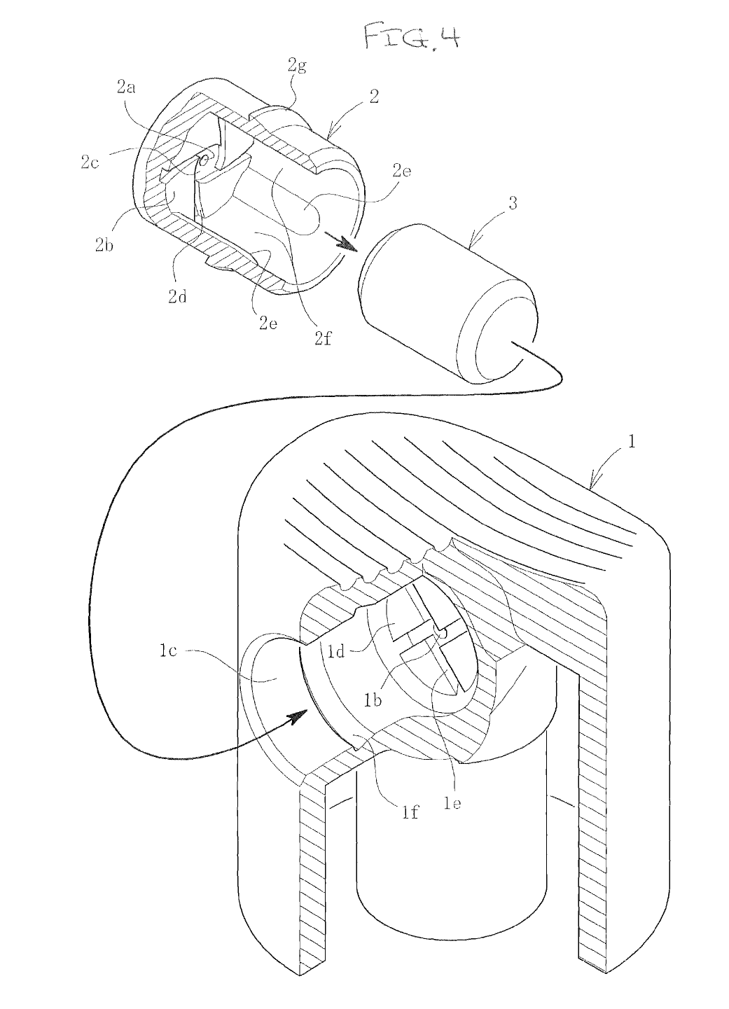

Preferred embodiments of the present invention will be described with reference to FIGS. 1 to 4.

It is fundamental features of the present invention corresponding to the embodiments that

1. the core 3 for flow passage setting is fixedly disposed in the space region between the output hole part 1b of the vertical passage 1a of the button body 1 and the discharge hole 2a of a content into the external space. The swirl flows in the same rotation direction are respectively formed through the upstream side recessed passage 1e continuously extending from the vertical passage 1a and through the downstream side recessed passage 2d extending to the discharge hole 2a. The rib 2e is formed for moving a plurality of the initial swirl flows produced through the upstream side recessed passages 1e(1) to 1e(4) to the corresponding downstream side recessed passages 2d(1) to 2d(4). These passages are separated from each other as far as possible.

Material qualities of the push button body 1, nozzle piece 2, core 3, and stem 4 are of plastic such as polypropylene, polyethylene, nylon, polyacetal, polybutylene terephthalate.

The content flow passage from the stem 4 to the discharge hole 2a is the content passage of the stem 4-vertical passage 1a of the push button body 1-its output hole part 1b-upstream side recessed passage 1e-space region 2f of the color member 2-downstream side recessed passage 2d-circular recessed part 2c-discharge hole 2a.

The upstream side recessed passage 1e of the push button body 1 has substantially the same cross sectional area for content passage at respective longitudinal positions. The downstream side recessed passage 2d of the nozzle piece 2 has a cross sectional area for content passage which is smaller, closer to the circular recessed part 2c than that far away from the circular recessed part 2c as shown in FIG. 3(b).

The four linear upstream side recessed passages 1e are formed at an equal interval on the bottom surface part 1d of the sheath-shaped space region 1c. The longitudinal central lines of passage 1e are shifted, so to speak, by the same phase from a radial direction of the bottom surface part (taking the output hole part 1b as a center). In other words, the longitudinal central line of the upstream side recessed passage 1e is prevented from intersecting the output hole part 1b.

More specifically, when a content passing through the upstream side recessed passage 1e strikes the internal peripheral surface of the sheath-shaped space region 1c, angles formed by a striking direction (flow direction of the content) and struck part are different at opposite sides of the struck part.

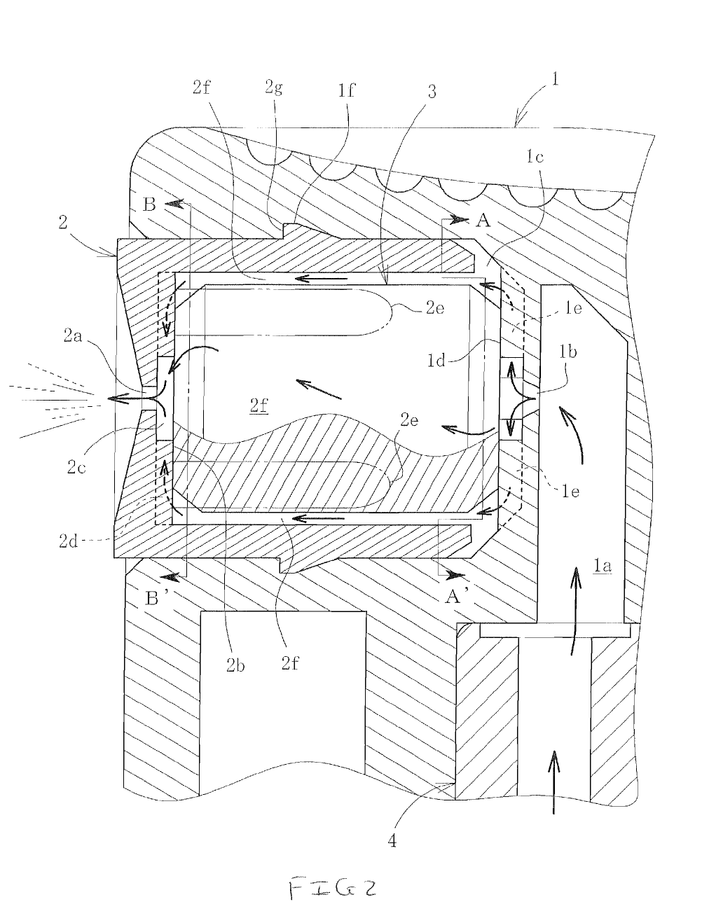

Therefore for contents striking the internal peripheral surface of the sheath-shaped space region 1c from the upstream side recessed passage 1e those swirling in a large angle direction form a main current (refer to FIG. 3(a)). The contents also undergo, as it were, drive force in a front direction owing to the action of a tapered surface of the struck part (refer to FIG. 2).

The contents, form the initial swirl flow like this, advances in one space region 2f as indicated by an arrow in FIG. 2 and enters the corresponding downstream side recessed passage 2d of the nozzle piece 2

There is herein illustrated in FIG. 3 correspondence between the four upstream side recessed passages 1e(1) to 1e(4)/down stream side recessed passages 2d(1) to 2d(4) and the initial swirl flows f1 to f4. Reference numbers with the same sub-numbers correspond to each other, e.g. the initial swirl flow f1 from the upstream side recessed passage 1e(1) enters the downstream side recessed passage 2d(1). It is herein noticed that the initial swirl flows f1 to f4 form substantially independent flows as a result of the separation action of the four ribs 2e.

Each of the initial swirl flows f1 to f4 entering the downstream side recessed passages 2d(1) to 2d(4) becomes a large single discharge swirl flow in the same direction at the circular recessed part 2c located and the contents becoming a fine mist that is sprayed into the external space from the discharge hole 2a.

It is of course that the present invention is not limited to the disclosures illustrated in FIGS. 1 to 4. For example, the upstream side recessed passage 1e may be formed in opposite abutment surface (with the bottom surface part) of the core 3 instead of the bottom surface part 1d of the sheath-shaped space region 1c and the bottom surface part of the nozzle piece 2. Additionally, they may be formed in both of the bottom surface part and the opposite abutment surface. Additionally, the rib 2e may be formed on the external peripheral surface of the core 3 instead of the internal peripheral surface of the nozzle piece 2. Also, they may be formed in both of the internal peripheral surface and in the external peripheral surface. Further more, the rib 2e may be an inclined form from the lateral direction in the figure (=longitudinal direction of the nozzle piece 2 and the core 3).

The physical nature of the container contents include liquids, expandable foam, pastes, gels, and powders.

Aerosol type products and pump type products to which the present invention is applicable include cleansing agents, cleaning agents, antiperspirants, coolants, muscle antiphlogistic agents, hair styling agents, hair treatment agents, hair washing agents, hair restorers, cosmetics, shaving foams, foods, droplet like products (such as vitamin), medical goods, quasi drugs, coating materials, gardening agents, repellant agents (insecticides), cleaners, deodorants, laundry starch, urethane foams, extinguishers, adhesives, lubricant agents or the like.

Contents in the container can include powdery products, oil components, alcohols, surfactants, high polymers, and effective components associated with various applications.

Powdery products includes metal salts powder, inorganic powder, and resin powder or the like, e.g. talc, kaolin, aluminum hydroxychloride (aluminum salt), calcium arginate, powdered gold, silver powder, mica, carbonate, barium sulphate, cellulose, and mixtures of them.

Oil components include silicone oil, palm oil, eucalyptus oil, camellia oil, olive oil, jojoba oil, paraffin oil, myristic acid, palmitic acid, stearic acid, linoleic acid, linolenic acid or the like.

Alcohols include monovalent lower alcohol such as ethanol, monovalent higher alcohol such as lauryl alcohol, and multivalent alcohol such as ethylene glycol or the like.

Surfactants include anionic surfactant such as sodium laurylsulphate, non-ionic surfactant such as polyoxyethylene oleyl ether, amphoteric surfactant such as lauryl dimethyl amino acetic acid betaine, and cationic surfactant such as alkylchloride trimethylammonium or the like.

Polymer molecule compounds include methylcellulose, gelatine, starch, and casein or the like.

Effective components associated with respective applications include antiphlogistics/analgesics such as methyl salicylate and indometacin, bacteria elimination agents such as sodium benzoate and cresol, harmful insect extermination agents such as pyrethroid, diethyltoluamide, anhidrotics such as zinc oxide, algefacient such as camphor and peppermint camphor, antiasthmatic agents such as ephedrine and adrenaline, edulcorant such as sucralose and aspartame, adhesive and paint such as epoxy resin and urethane, dyes such as paraphenylenediamine and aminophenol, and extinguishant such as ammonium dihydrogenphosphate and sodium/potassium acid carbonate or the like.

Further, the contents can include usable suspensions, UV absorbers, emulsifiers, humectants, antioxidants, and metal ion blocking agents, etc.

Content discharge gas in the aerosol type product includes carbon dioxide, nitrogen gas, compressed air, oxygen gas, rare gas, such as helium, neon, and argon, compressed gas of mixed gas etc. of the former gases, liquefied petroleum gas, and liquefied gas of dimethyl ether and fluorocarbon etc.

What is claimed:

1. A content discharge mechanism comprising:
a member for passage including a downstream passage region for a content and a sheath-shaped space region on a bottom surface of which an output part of said downstream passage region is formed;
a sheath-shaped discharge member attached to said sheath-shaped space region with its side of said output part being opened and including a hole for content discharge formed in its bottom surface on an external space side located oppositely to said side of said output part;
a core-shaped member making contact with respective bottom portions of said sheath-shaped space region and said discharge member and fixed to said member for passage and the discharge member to produce the space for passage of the content between it and an internal peripheral surface of said discharge member;
a plurality of upstream side passages provided on at least one of abutment parts of said member for passage and said core-shaped member so as to communicate said output part of said downstream passage region and said space for passage; and
a plurality of downstream side passages provided on at least one of the abutment parts of said discharge member and said core-shaped member for guiding the content advancing from said space for passage in the form of a spiral flow to said hole part for content discharge in the same direction as the spiral flow.

2. The content discharge mechanism according to claim 1 wherein a plurality of rib-shaped parts are formed on at least one of the internal peripheral surface of said discharge member and an external peripheral surface for individually restricting a flow of the content from each of the upstream side passages and for guiding and holding said core-shaped member.

3. An aerosol type product including the content discharge mechanism according to claim 1 and accommodating discharging gas and a content.

4. A pump type product including the content discharge mechanism according to claim 1 and accommodating a content.
